(19) United States
(12) Patent Application Publication
(10) Pub. No.: US 2005/0162699 A1
(43) Pub. Date: Jul. 28, 2005

(54) Index printing device, instant film, service server, and servicing method

(75) Inventors: Yoshitsugu Fukunaga, Tokyo (JP); Ryo Suzuki, Tokyo (JP); Takuya Shimomura, Tokyo (JP); Tadashi Suzuki, Tokyo (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/037,246

(22) Filed: Jan. 19, 2005

(30) Foreign Application Priority Data
Jan. 22, 2004 (JP) 2004-14636
Jan. 26, 2004 (JP) 2004-17248

(51) Int. Cl. G06F 15/00

(52) U.S. Cl. 358/1.18; 358/1.15

(57) ABSTRACT

According to the present invention, a taken picture or additional information on the picture can be easily accessed from any user's user terminal on the basis of an index print or an instant film and users can easily enjoy the picture or additional information. Moreover, the present invention makes the best of a marginal frame section on an instant film to please a user with services other than just decorating the space.

### BACKGROUND OF THE INVENTION

1. Field of the Invention

The present invention relates to an index printing device, an instant film, a service server, and a servicing method, more specifically to an index printing device for printing an index including more than one picture, an instant film for recording a picture with an instant camera, a service server and a servicing method for delivering information to users' terminals such as cellular phones over a network.

2. Description of the Related Art

Generally, photo-printing shop or the like produces an index print, which is a sheet of paper printed with a list of pictures, to fill a user's order or for free and gives the index print to the user with normal sized pictures the user ordered. The index print helps a user in ordering an extra copy of pictures. A user makes another order with reference to the index print, for example, another copy of picture No. 1 and three copies of picture No. 3.

As camera cellular phones are widespread, people can readily take a picture and send it. A technology has been proposed for taking a picture with a camera cellular phone of a two dimensional barcode such as a QR code (Registered Trademark) printed on an advertising medium including a poster, a banner hung in a train, or a town information magazine and decoding the taken picture of two dimensional barcode to obtain information (Japanese Patent Application Laid-open No. 2002-118680).

Another technology for a user to easily print a desired illustration with a sole printing device has also been proposed (See Japanese Patent Application Laid-open No. 8-142440). In this technology, a barcode reader is connected to a printing device. The technology enables a user to print a selected illustration on a sheet of paper by reading out a barcode from a list of illustrations containing both illustrations and barcodes to select a desired illustration, and reading out a picture corresponding to the selected illustration from a recording device in the printing device.

An instant film has two types; a peel-apart type with a cover to be peeled and a mono-sheet type with no cover to be peeled. Each type features a photograph print being provided just after the picture is taken.

An instant film of mono-sheet type usually has a developer pod containing developing solution and a trap material for receiving the remaining developing solution. The instant film has a frame section surrounding a print section where a picture is printed.

The frame section usually has a white surface for a message to be written with a writing material if needed. Some types of frame section have a pattern of stripes or dots, or a picture of an animation character on it to please a user's eyes (See Japanese Patent Application Laid-open No. 2003-29383).

### SUMMARY OF THE INVENTION

The conventional index prints are mainly used for a user to make an additional order and generally can not be used for other purposes.

Even if a user is given a photograph print with a clearly printed picture, the user is not very much pleased by just looking at the photograph. If a photograph print can provide a group of users with pleasure in other ways based on pictures taken by the users in addition to the pleasure of looking at a printed photograph, the users will be more pleased.

An instant film with a decorative frame section can please a user's eyes more than that with a white frame section does. However, a space for pleasing user's eyes is just limited to the frame section which is formed for providing a developer pod and a trap material film.

If a user can have other various ways of enjoying a picture in addition to just looking at a taken picture or a printed picture, while best utilizing this limited space in a frame section, the user will be more pleased. If various ways of enjoying a picture stimulate a user's interests or expectation, demand for instant films or instant cameras increases.

The conventional technology described in Japanese Patent Application Laid-open No. 2002-118680 merely provides fixed information registered with a Web site. Even with this technology, a group of users cannot easily select desired pictures respectively from a plurality of pictures that one of the users placed an order for printing and display the pictures or play additional information on a user terminal such as a cellular phone.

The conventional technology described in Japanese Patent Application Laid-open No. 8-142440 also merely provides a fixed illustration stored in a printing device. Also with this technology, a group of users cannot select desired picture from a plurality of pictures that one of the users placed an order for printing and display the pictures or play additional information on a user terminal such as a cellular phone.

Although a wallpaper for a cellular phone can be obtained over a network, a user is confused in obtaining a desired picture. As a screen of a cellular phone is small, a user has a hard time to find a desired picture by obtaining a picture one by one. Therefore, many users set a picture taken by them or a general picture obtained from a famous Web site or the like as a wallpaper. In other words, users cannot easily select a desired picture from a plurality of pictures taken by other users and set the picture as a wallpaper.

The present invention is adapted in view of the above circumstance. An object of the present invention is to provide an index printing device, an instant film, a service server, and a servicing method to provide users with easy and pleasant ways of enjoying a printed picture, instead just providing users with a printed picture.

Another object of the present invention is to make the best of a marginal frame section on an instant film and please a user with services other than just decorating the space.

In order to achieve the abovementioned objects, the first aspect of the present invention is an index printing device including a picture obtaining device for obtaining at least one picture of a user whose order for printing is received, an access information obtaining device for obtaining access information unique to each picture, and a printing device for printing the at least one picture of a user on a sheet of print medium for index print and recording the access information unique to each picture in association with each picture.

With this configuration, as access information unique to each picture of a user whose order for printing is received is printed when an index print is made, the user can easily select to access a desired picture on the basis of the index print. Thus, users who have an index print delivered easily enjoy communicating with each other.

The second aspect of the present invention is in the first aspect, wherein the print medium is an adhesive sheet, which allows a section having the access information printed thereon to be peeled off and applied to another medium.

With this configuration, a section having access information printed thereon can be peeled off and applied to a desired place associated with the picture. A user can choose any place to apply the peeled off section. The place can be a standard type photograph print with the picture printed thereon, a place corresponding to the picture in an album containing the photograph print, or something owned by a person who is an object of the picture.

The adhesive sheet may be a sheet adapted to peel off only the corresponding section having access information printed thereon or to peel off both a section having access information printed thereon and a section with a picture printed thereon together.

In the third aspect of the present invention, the access information is information for accessing each picture of the user or additional information associated with each picture of the user registered with a predetermined database over a network.

In the fourth aspect of the present invention, for example, the printing device prints the access information on a print medium in the form of a two-dimensional barcode. In the fifth aspect of the present invention, for example, the access information is printed on a print medium in the form of text. The text can be a character string representing a URL (Uniform Resource Locator) or a character string specific to a system.

The sixth aspect of the present invention is in the third aspect, wherein the printing device includes writing device for writing the access information on an IC (Integrated Circuit) tag formed on the print medium.

The seventh aspect of the present invention is a service server for communicating over a network with a user terminal that uses access information on an index print produced by an index printing device described in any of the first to sixth aspects, including a database for managing each picture of a user whose order for printing is received and a sending device for reading out a picture corresponding to the access information from the database and sending the picture to the accessing user terminal in response to an access using the access information on an index print from the user terminal.

With this configuration, a user can easily select to easily access a desired picture on the basis of an index print. Users who have the index print delivered can enjoy the pictures in an easy and pleasant way of displaying a desired picture on the user terminals. Users also easily set the pictures as a wallpaper.

The eighth aspect of the present invention is a service server for communicating over a network with a user terminal that uses access information on an index print produced by an index printing device described in any of the first to sixth aspects, including a database for managing additional information associated with each picture of a user whose order for printing is received in association with each picture and a sending device for reading out additional information on a picture corresponding to the access information from the database and sending the additional information to the accessing user terminal in response to an access using the access information on an index print from the user terminal.

With this configuration, a user can easily select a desired picture to easily access additional information such as a sound associated with the picture on the basis of an index print. Users who have the index print delivered can enjoy the picture in an easy and pleasant way of displaying additional information on a desired picture on the user terminals. For example, if a voice of an object of a picture is obtained and played, the object in the picture seems to be speaking and a user feels that the object is there in person. This provides much pleasure to users.

The ninth aspect of the present invention is a service server for communicating over a network with a user terminal that uses access information on an index print produced by an index printing device described in any of the first to sixth aspects, including a receiving device accessed from the user terminal that uses access information on an index print, the receiving device for receiving additional information on a picture corresponding to the access information, a database for managing the received additional information in association with each picture, and a sending device for reading out additional information on a picture corresponding to the access information from the database and sending the additional information to the accessing user terminal in response to an access using the access information on an index print from the user terminal.

With this configuration, a user can easily select a desired picture to easily register additional information such as a sound later on the basis of an index print. Users who have the index print delivered can not only easily play the additional information but also easily register the additional information to enjoy it. If only a picture is previously obtained, for example, if a picture is read in from a silver-salt film recording the picture taken by a camera and previously registered with a database of the service server, additional information such as a sound can be easily and freely registered with the service server.

In the tenth aspect of the present invention, the additional information includes at least one of sound information, text information, background music, location information indicating where the picture was taken, and picture information.

The eleventh aspect of the present invention is adapted to receive an order for printing at least one picture of a user, register each of the pictures of a user whose order for printing is received with a predetermined database, issue access information unique to each picture for accessing each picture registered with the database over a network, print at least one picture of the user on a sheet of print medium for index print, while recording access information unique to each of the pictures on the print medium in association with each picture, and read out a picture corresponding to the access information from the database and send the picture to the accessing user terminal in response to an access from a user terminal that uses the access information on an print medium.

The twelfth aspect of the present invention is adapted to receive an order for printing at least one picture of a user, register additional information associated with each of the pictures of a user whose order for printing is received with a predetermined database in association with each picture, issue access information unique to each picture for accessing additional information on each picture registered with the database over a network, print at least one picture of the user on a sheet of print medium for index print, while recording access information unique to each of the pictures on the print medium in association with each picture, and read out additional information on a picture corresponding to the access information from the database and send the additional information on the accessing user terminal in response to an access from a user terminal that uses the access information.

The thirteenth aspect of the present invention is adapted to receive an order for printing at least one picture of a user, issue access information unique to each of the pictures, print at least one picture of the user on a sheet of print medium for index print, while recording access information unique to each of the pictures on the print medium in association with each picture, be accessed from a first user terminal by using the access information and receive additional information on a picture corresponding to the access information, register the received additional information with a predetermine database in association with each picture, and read out additional information on a picture corresponding to the access information from the database and send the additional information to an accessing second user terminal in response to an access from the second user terminal that uses the access information on an print medium.

The fourteenth aspect of the present invention is an instant film including a print section in which a taken picture of an object is to be printed and a frame section surrounding the print section, wherein an access information for a user terminal to obtain digital contents that can be played by the user terminal over a network from a predetermined server is recorded in the frame section.

With this configuration, as access information for obtaining digital contents that can be played on the user terminal is recorded on a frame section, a user not only can enjoy looking at a taken picture of an object but also can enjoy the picture by having a user terminal download the digital contents from the server over a network and display the digital contents.

In the fifteenth aspect of the present invention, the access information is, for example, recorded on the frame section in the form of two-dimensional barcode.

Other aspects include an aspect of writing the access information on an IC (Integrated Circuit) tag formed on a frame section in the form of digital data or an aspect of printing a string of alphanumeric characters representing the access information in character font.

The access information actually includes a URL (Uniform Resource Locator). A URL includes a communication protocol required to obtain digital contents, a domain name of a server, and information for identifying the place storing digital contents. The access information is not limited to such a URL and can include a code that can be identified between a user terminal and a server.

The sixteenth aspect of the present invention is a service server for communicating with a user terminal over a network and collecting sound information from the user terminal, including a database for storing sound information in association with access information recorded on the instant film described in the fourteenth or fifteenth aspect, an access information inputting device to which access information on an instant film with a picture printed thereon is input from a user terminal over a network, a sound information inputting deice to which sound information is input from a user terminal, which sent the access information, over a network, a registering device for registering sound information input from the user terminal, which sent the access information, with the database in association with the access information, and a sound information outputting device for outputting a group of pieces of sound information for each piece of access information stored in the database.

With this configuration, a user can easily collect sound information from user terminals of other users by delivering an instant film with a picture printed thereon.

The seventeenth aspect of the present invention is in the sixteenth aspect, wherein the sound information outputting device retrieves a group of pieces of sound information for each piece of access information stored in the database from the database and records the group of pieces of sound information on a removable recording medium.

The eighteenth aspect of the present invention is a service server for communicating with a user terminal over a network and delivering digital contents that can be played on the user terminal to the user terminal, including a database for managing digital contents to be delivered to a user terminal in association with access information recorded on the instant film described in the fourteenth or fifteenth aspect, access an information inputting device to which access information on an instant film with a picture printed thereon is input from a user terminal over a network, and a delivering device for delivering digital contents managed in the database in association with the received access information to the user terminal.

With this configuration, a user can easily play and enjoy digital contents in addition to just looking at a picture printed on an instant film.

In the nineteenth aspect of the present invention, the digital contents is, for example, sound information, moving picture information, still picture information, text information, animation information of vector graphics, or a multimedia file including the combination thereof.

The twentieth aspect of the present invention includes the steps of receiving an input of access information recorded on the instant film described in the fourteenth or fifteenth aspect from a user terminal over a network, receiving an input of sound information from the user terminal that sent the access information over a network, registering sound information input from the user terminal that sent the access information with a predetermined database in association with the access information, and outputting a group of pieces of sound information for each piece of access information stored in the database.

The twenty-first aspect of the present invention includes the steps of registering digital contents to be delivered to a user terminal with a predetermined database in association with access information recorded on the instant film described in the fourteenth or fifteenth aspect, receiving an input of access information on an instant film with a picture printed thereon from a user terminal over a network, and delivering digital contents managed in the database in association with the received access information to the user terminal over a network.

According to the present invention, a taken picture or additional information on the picture can be easily accessed from any user's user terminal on the basis of an index print or an instant film and users can easily enjoy the picture or additional information.

The present invention makes the best of a marginal frame section on an instant film to please a user with services other than just decorating the space.

### BRIEF DESCRIPTION OF THE DRAWINGS

FIG. 1 is a diagram of a whole service system including a printing device of an embodiment and a service server of a first embodiment according to the present invention;

FIG. 2 is a block diagram illustrating an exemplary inner structure of a service server of a first embodiment according to the present invention;

FIG. 3 is a block diagram illustrating an exemplary inner structure of printing device of an embodiment according to the present invention;

FIG. 4 is a diagram illustrating an example of index print having printed access information;

FIG. 5 is a flow chart illustrating an exemplary service flow for creating an index print of pictures uploaded from a user terminal;

FIG. 6 is a flow chart illustrating an exemplary service flow for creating an index print of pictures uploaded from a printing device;

FIG. 7 is a perspective view of the exterior of an instant film of an embodiment according to the present invention;

FIG. 8 is a perspective view of the main parts of an instant film of an embodiment according to the present invention;

FIGS. 9A and 9B are sectional views of a frame section in an instant film of an embodiment according to the present invention;

FIG. 10 is a diagram of a whole service system including a service server of a second embodiment according to the present invention;

FIG. 11 is a block diagram illustrating an example of a specific inner structure of a service server of a second embodiment according to the present invention;

FIG. 12 is a block diagram illustrating a conceptual structure of a service server of a second embodiment according to the present invention;

FIG. 13 shows a process flow of a sound collecting service by a service server of a third embodiment according to the present invention;

FIG. 14 is a block diagram illustrating a conceptual structure of a service server of a third embodiment according to the present invention;

FIG. 15 shows a process flow of a contents delivering service by a service server of a third embodiment according to the present invention; and

FIG. 16 is a diagram of an exemplary instant film with picture printed on it.

### DETAILED DESCRIPTION OF THE PREFERRED EMBODIMENTS

Now, the preferred embodiments for implementing the present invention will be described in detail with reference to attached drawings.

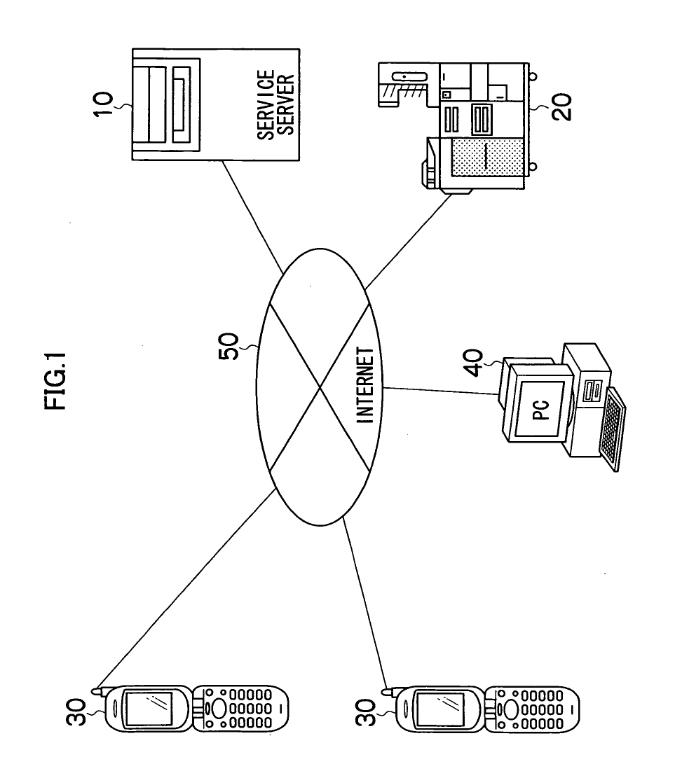

FIG. 1 is a diagram of an exemplary whole service system including an index printing device and a service server of a first embodiment according to the present invention.

In FIG. 1, a service system is composed mainly of a service server 10, a printing device 20 (Index printing device), cellular phones 30, and a personal computer 40 (hereinafter referred to as “PC”), each connected to Internet 50 (network).

The cellular phone 30 is provided with a camera (not shown) that can take a picture of an object. A picture of an object taken with a camera of the cellular phone 30 can be uploaded to the service server 10 over Internet 50. If the cellular phone 30 has a function of detecting the present location with GPS (Global Positioning System), location information (longitude, latitude) indicating where the picture was taken can be uploaded to the service server 10 as additional information with a picture. Sound input into a microphone (not shown) of the cellular phone 30 or background music (BGM) stored in memory (not shown) of the cellular phone 30 can also be uploaded to the service server 10 as additional information with a picture. Text information input with buttons (not shown) on the cellular phone 30 can also be uploaded to the service server 10 as additional information with a picture.

A camera of the cellular phone 30 is also used for reading two-dimensional barcode such as QR code (Registered Trademark). The cellular phone 30 can decode a two-dimensional barcode read with the camera, access the service server 10 according to what obtained from the decoding (representing access information), and download various types of information from the service server 10 over Internet 50.

The service server 10 receives requests for various services from the cellular phone 30 over Internet 50 and performs services corresponding to the requests for services.

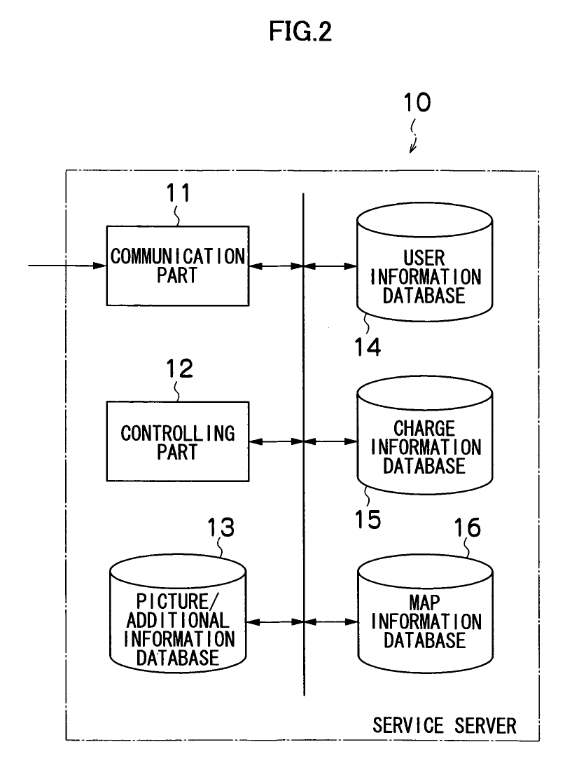

FIG. 2 is a block diagram illustrating an exemplary inner structure of the service server 10 of a first embodiment. In FIG. 2, the service server 10 is composed mainly of a communication part 11 that can communicate according to HTTP (Hypertext Transfer Protocol), a controlling part 12, and various databases 13, 14, 15, and 16. The picture/additional information database 13 manage a picture and additional information on the picture uploaded from the cellular phone 30 or the like. The user information database 14 manages user information including owner ID identifying the owner of a picture or the like, a password, a name, a street address, and a mail address. The charge information database 15 manages charge information on a user including the number of prints, the size of a print, the type of print (e.g., so-called “photograph print” or “index print”), the print charge, and the storage fee for a picture. The map information database 16 manages map information that is associated with location information (longitude, latitude) obtained by the cellular phone 30 with GPS. The communication part 11 can communicate by means of an e-mail message according to SMTP (Simple Mail Transfer Protocol) instead of HTTP. The e-mail message can be attached with a picture or additional information.

The controlling part 12 of the service server 10 has control over each part of the service server 10 and includes information providing software for providing various types of information for a browser (browsing software) run in a user terminal such as the cellular phone 30 or the PC 40. After the communication part 11 of the service server 10 receives a picture that is ordered for printing and additional information on the picture from the cellular phone 30 or the printing device 20, the controlling part 12 of the service server 10 registers the picture and additional information with the picture/additional information database 13 and issues access information for accessing each picture or additional information registered with the picture/additional information database 13. For example, URL (Uniform Resource Locator) is used as access information. For such purpose of reducing the size of a print of a two-dimensional barcode, identification information featuring this service including a string of alphanumeric characters can be used instead of a URL.

When order information (details of an order for printing including a picture ordered for printing, the number of prints, the size of a print, the type of print) is uploaded from the cellular phone 30, the controlling part 12 of the service server 10 issues access information corresponding to the order information and sends the access information with the order information from the communication part 11 to the printing device 20.

When order information is uploaded from the printing device 20, the controlling part 12 of the service server 10 also issues access information corresponding to the order information and sends the access information with the order information to the printing device 20 from the communication part 11.

When order information is uploaded from the cellular phone 30 or the printing device 20, additional information may or may not be added to a picture. There are some cases that the cellular phone 30 has no function for adding additional information, that a user has not manipulated the cellular phone 30 to add additional information, or that only a picture is read by the printing device 20. Even in such cases, additional information can be added to a picture already registered with the picture/additional information database 13 after only a picture is uploaded to the service server 10. Moreover, when additional information has already added to a picture registered with the picture/additional information database 13, the additional information can be updated or added.

Specifically, when the controlling part 12 of the service server 10 is accessed from the cellular phone 30 by using access information, the controlling part 12 receives additional information from the cellular phone 30 and adds additional information to a picture corresponding to the access information. The picture/additional information database 13 manages the received additional information in association with each picture. The picture/additional information database 13 can also corporate with a background music site and manage access information in association with background music.

When the controlling part 12 of the service server 10 receives access information, which sent from a user terminal such as the cellular phone 30 or the PC 40, at the communication part 11, the controlling part 12 reads out the targeted picture and additional information indicated by access information from the picture/additional information database 13 and sends the picture and additional information to the requesting user terminal that sent the access information.

The printing device 20 prints a picture on a predetermined sheet of paper.

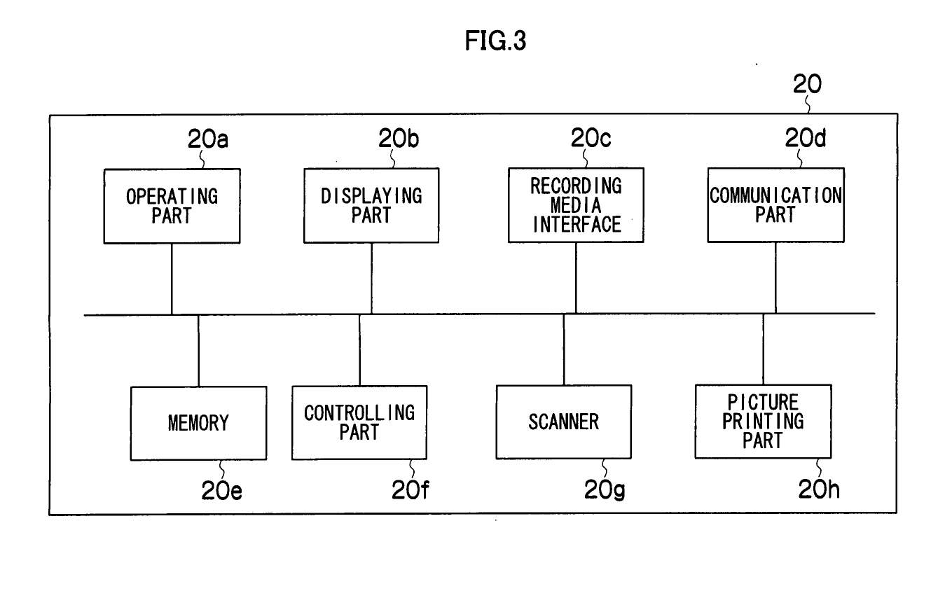

FIG. 3 is a block diagram illustrating an exemplary inner structure of the printing device 20. In FIG. 3, the printing device 20 is composed mainly of an operating part 20a, to which an operator inputs an instruction, a displaying part 20b for displaying various types of information, a recording media interface 20c that can read out a picture or additional information on a picture from a recording media such as a memory card, a communication part 20d that can communicate with the service server 10 over Internet 50, a memory 20e for storing various types of information, a controlling part 20f for controlling over each part of the printing device 20, a scanner 20g that can read out a picture recorded in a film, and a picture printing part 20h for printing a picture on a predetermined sheet of paper.

The printing device 20 can obtain a picture in various ways. First, the printing device 20 can obtain a picture at the communication part 20d from the service server 10 over Internet 50 and print the picture at the picture printing part 20h. Second, the printing device 20 can obtain a picture from a recording media such as a memory card via the recording media interface 20c and print the picture at the picture printing part 20h. Third, the printing device 20 can read out a picture from a silver-salt film recording the picture taken by a camera and print the picture at the picture printing part 20h.

The printing device 20 supports various types of prints. A sheet of paper with a picture printed on it is generally called “print.” A sheet of paper with a picture printed on it is called “photograph print,” and a sheet of paper with a list of pictures is called “index print.”

In order to obtain a picture from the service server 10, the printing device 20 obtains access information unique to each picture along with the picture at the communication part 20d from the service server 10. Similarly, in order to obtain picture data via the recording media interface 20c or the scanner 20g, the printing device 20 obtains access information unique to each picture at the communication part 20d from the service server 10.

In order to print an index print, the printing device 20 prints a plurality of pictures and access information in association with each picture on a sheet of paper under control of the controlling part 20f.

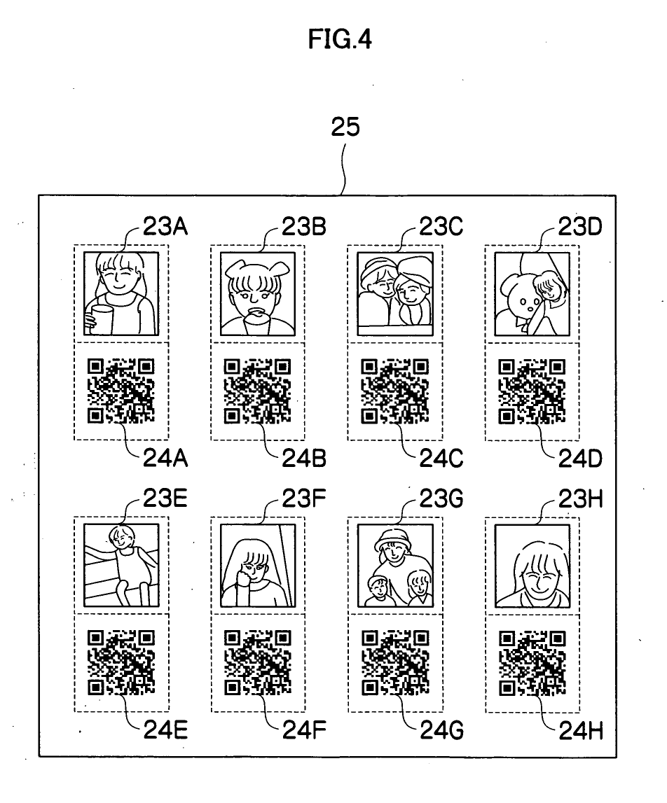

FIG. 4 is a schematic diagram illustrating an example of an index print 25. Two-dimensional barcodes 24 (24 A, 24 B, 24 C, 24 D, 24 E, 24 F, 24 G, 24 H) for accessing a picture and additional information on the picture stored in the picture/additional information database 13 is printed near (here, below) each picture 23 (23 A, 23 B, 23 C, 23 D, 23 E, 23 F, 23 G, 23 H) on the index print 25. In other words, two-dimensional barcodes 24 unique to each picture is printed in association with each picture 23.

For example, when two-dimensional barcode 24A associated with a first picture 23A is read by a camera of the cellular phone 30, the two-dimensional barcode 24A is decoded at the cellular phone 30. Then the cellular phone 30 accesses the service server 10 over Internet 50 on the basis of access information represented by the two-dimensional barcode. A picture is downloaded to cellular phone 30 and displayed there. When sound information is added to the picture, the sound information is downloaded with the picture to the cellular phone 30. Then, the cellular phone 30 outputs the sound. When text information is added to the picture, the text information is downloaded with the picture to the cellular phone 30. If a user switches a display mode with buttons on the cellular phone 30, image display changes to text display and text information associated with the picture is displayed on the cellular phone 30. When location information is added to the picture, indicating a location where the picture was taken, map information showing the location where the picture was taken is provided for the cellular phone 30. If a user switches a display mode with buttons on the cellular phone 30, image display changes to map display and a map showing where the picture was taken is displayed on the cellular phone 30.

The index print 25 shown in FIG. 4 is printed on an adhesive sheet with tear-off lines that are denoted by dashed lines in FIG. 4. For example, the adhesive sheet may have perforation along dashed lines shown in FIG. 4 so that a user can peel off the adhesive sheet from its backing sheet along a dashed line in FIG. 4 and apply the peeled off sheet to another medium. For the index print 25 shown in FIG. 4, a section with a two-dimensional barcode printed thereon and a section with a picture printed thereon can be peeled off independently. The present invention is not limited to this example, and a section with a picture printed thereon and a section with a two-dimensional barcode printed thereon may be pealed off together so that a picture and access information can be applied to somewhere together.

Next, specific flows of a service in the abovementioned service system will be described. Two embodiments of print (the first print embodiment and the second print embodiment) will be described individually.

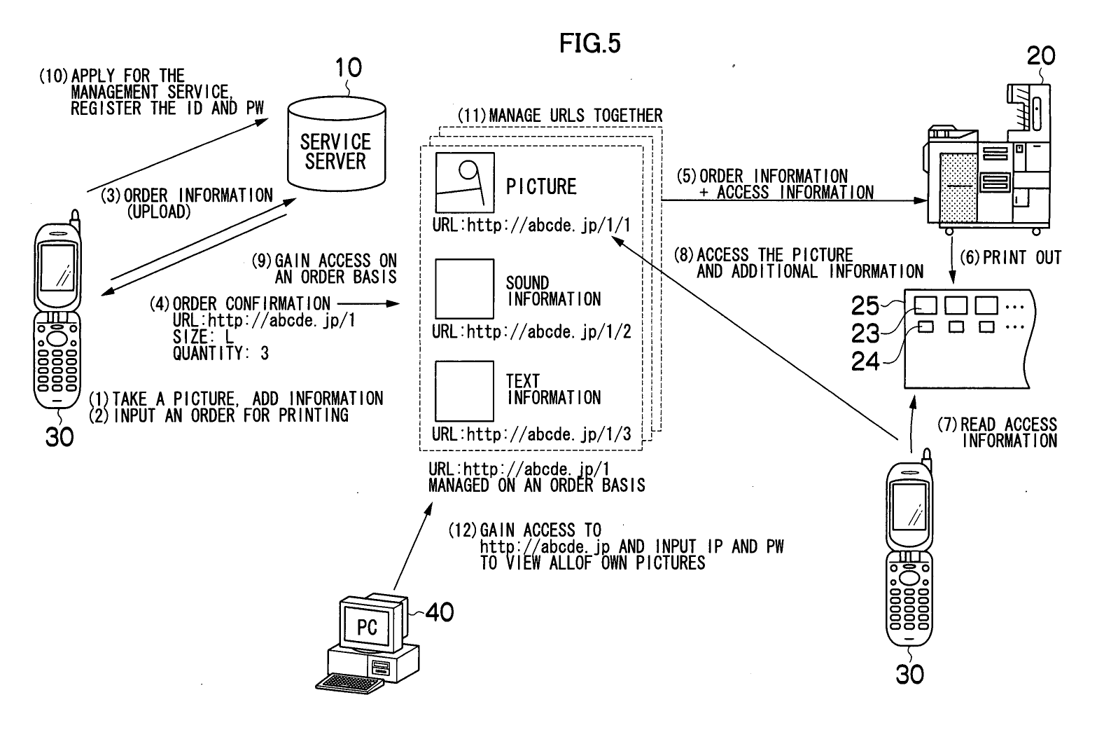

Now, a flow of a service in the first print embodiment, i.e., an embodiment where a picture is uploaded from the cellular phone 30 to the service server 10 and printed at the printing device 20 will be described with reference to FIG. 5.

(1) A user takes a picture with cellular phone 30 and stores the picture on a recording medium in the cellular phone 30. When the user stores the picture, various types of information can be attached to the taken picture. For example, if cellular phone 30 can detect its present location with GPS, location information indicating where the picture is taken can be attached to the picture. Additional information to be attached to a picture includes sound information, text information, background music (BGM) as 2 well as location information. In order to attach sound information to a picture at the cellular phone 30, the user selects an item on a menu to input sound information, while the cellular phone 30 displaying the picture, records sound by pressing RECORD button assigned to a button on the cellular phone 30, and finishes the recording by pressing STOP button.

When the user has recorded sound in this manner, a sound file in WAV format (Wave format), for example, is made and recorded on a recording medium in the cellular phone 30. A picture file and a sound file are recorded in association with each other. When a file name for a picture file is “DSCF0001.JPG”, a sound file can be associated with the picture file by taking a file name “DSCF001.WAV” with only an extension different from that of the picture file.

Additional information including sound information and location information does not need to be attached to a taken picture.

(2) The user accesses the service server 10 from the cellular phone 30 and selects pictures to print from pictures stored on a recording medium in the cellular phone 30 on a print order screen sent from the service server 10 to the cellular phone 30. The user may set the size of a print or the number of prints for each picture to be printed. The user may request for an index print with a list of selected pictures printed on it. Sound information for pictures can be added to each picture when a user selects pictures to order for printing.

(3) When the user inputs details of an order for printing and presses SEND button on the cellular phone 30, order information including selected pictures, the size of a print, the number of prints, and the type of print is uploaded from the cellular phone 30 to the service server 10. If additional information is added to a picture, the additional information is uploaded to the service server 10 with the picture. The type of print includes whether or not to produce an index print.

When the service server 10 receives the order for printing, it manages the received pictures and additional information in the picture/additional information database 13 for each order by treating the pictures and the additional information as a unit (picture/additional information).

(4) The service server 10 sends order confirmation to the cellular phone 30. For this purpose, the service server 10 generates access information (e.g., URL) for accessing pictures and additional information managed in the picture/additional information database 13 order by order. The order confirmation includes the size of a print, the number of prints, the type of print, the print charge, and the delivery time information as well as access information.

(5) Order information including pictures, the size of a print, the number of prints, and the type of print is sent with access information to the printing device 20. Access information may be encoded into a two-dimensional barcode at the service server 10 and sent to the printing device 20. For example, the service server 10 converts a URL into a two-dimensional barcode and sends the barcode to the printing device 20. A URL may be encoded into a two-dimensional barcode at the printing device 20.

(6) The printing device 20 produces a photograph print or an index print on the basis of the order information and access information received form the service server 10. An index print includes not only multiple pictures but also access information unique to the picture associated with each picture. Pictures are printed small on an index print. The produced photograph print and index print are delivered to the user's house or the place specified by the user.

Whether or not to produce an index print may be specified by a user when the user makes an order for printing at the cellular phone 30 and informed to the printing device 20 via the service server 10. The service server 10 may request the printing device 20 to produce an index print for free even if the user does not request for an index print.

(7) When the user obtains an original picture of the index print and the additional information at the cellular phone 30, the user sets the cellular phone 30 to access information reading mode and recognizes access information on the index print. For example, the cellular phone 30 reads and decodes a two-dimensional barcode to obtain a URL.

(8) When the user accesses the picture and additional information by using the obtained access information, the service server 10 provides the user with a service corresponding to the access information.

First, the service server 10 sends the picture corresponding to the access information to the cellular phone 30. The cellular phone 30 displays the picture. The picture downloaded to the cellular phone 30 may be set as a wallpaper on the cellular phone 30.

Second, the service server 10 sends additional information corresponding to the access information to the cellular phone 30. The cellular phone 30 plays the additional information. When sound information or background music is added to a picture, the cellular phone 30 plays the sound or background music. When location information is added to a picture, the service server 10 has the cellular phone 30 display a map indicating where the picture was taken. In other words, the service server 10 reads out map information on a predetermined area with the location indicated by location information in the center from the map information database 16 on the basis of location information added to the picture. Then the service server 10 sends the map information to the cellular phone 30 and has the cellular phone 30 display the map information.

When a picture has multiple types of additional information, a user may select desired type. For example, a user may switch the type of additional information between text information and map information including information on location where the picture was taken.

(9) Similarly, when a user accesses a picture and additional information from the cellular phone 30, from which the user sent an order for printing, by using access information obtained from order confirmation, the user can view pictures for each order and also get the additional information.

This service system stores the pictures and additional information and provides the abovementioned services for a certain period from the acceptance of the order for printing. When the certain period elapses, this service system finishes providing the abovementioned services. The period for storing the picture and additional information can be extended by paying an additional charge (storage charge).

In the example shown in FIG. 5, uploaded pictures are managed for each order in principle, instead of for each user. Therefore, with access information obtained from order confirmation, a user can view pictures or request for an index print for each order but cannot view all the pictures the user has uploaded at a time. If a user wants a service for displaying all the pictures the user has uploaded at once, the user needs to apply for Owner Picture Management Service.

(10) When a user applies for Owner Picture Management Service, the user sets and registers the owner ID and the password. The user has to pay an additional charge for Owner Picture Management Service. When a user applies for Owner Picture Management Service, software collects all URLs from order confirmations stored in the cellular phone 30 and sends the collected URLs, the owner ID, and the password to the service server 10.

(11) The service server 10 makes a page for the user to view in association with all the received URLs. Thereafter, the service server 10 manages pictures for the owner by the owner ID and the password.

(12) Owner Picture Management Service can also be accessed from the PC 40. A user can enter the owner page by accessing service server 10 by using a specific URL and inputting the owner ID and the password on the specific input screen. The owner page is divided into two: one for cellular phone 30 and the other for the PC 40. The owner page for the PC 40 has more enhanced functions.

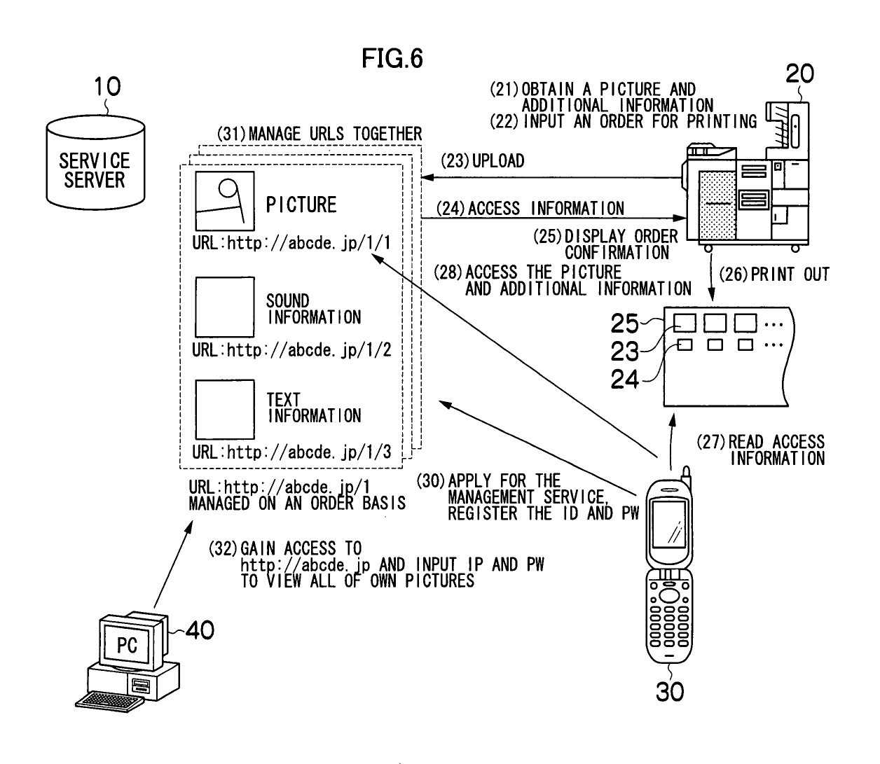

Next, a flow of a service will be described for the second print embodiment, i.e., an embodiment where a picture is directly obtained and printed at the printing device 20 with reference to FIG. 6.

(21) The printing device 20 obtains a picture of a user and additional information. The printing device 20 supports various embodiments for obtaining pictures. First, when a picture is recorded on a silver-salt film taken by a camera, the printing device 20 directly reads the picture from the film with a scanner and obtains the picture as digital data. Second, when a picture is recorded on a recording medium such as a memory card with a cellular phone or a digital camera, the printing device 20 obtains the picture from the recording medium via a recording medium interface. The printing device 20 can also obtain the picture by wirelessly performing short-range communication with a cellular phone or the like. As a picture is obtained by respective known technologies in the abovementioned aspects of obtaining pictures, detailed descriptions of the technologies are omitted. When additional information such as sound information or text information is added to a picture, the printing device 20 obtains the additional information with the picture. When additional information is not added to a picture, the printing device 20 only obtains the picture.

(22) Details of a user's order for printing including selection of pictures to print, and the size of a print, the number of prints, and whether or not to produce an index print for each picture are input in the printing device 20.

(23) Order information including pictures ordered to be printed, the size of a print, the number of prints, and whether or not to produce an index print is uploaded from the printing device 20 to the service server 10. If additional information is added to a picture, the additional information is also uploaded to service server 10 with the order information.

The service server 10 manages the received pictures and additional information in the picture/additional information database 13 for each order by treating the pictures and additional information as a unit (pictures/additional information).

(24) The service server 10 generates access information (e.g., URL) for accessing the pictures and additional information managed in the picture/additional information database 13 for each order and sends the access information to the printing device 20. The access information can be encoded into a two-dimensional barcode at the service server 10 and sent to the printing device 20 or encoded into a two-dimensional barcode at the printing device 20.

(25) The printing device 20 displays the order confirmation including information that pictures are received at the service server 10.

(26) The printing device 20 makes photograph prints and an index print on the basis of the order information input at the printing device 20 and the access information received from the service server 10. Not only small sized pictures but also access information unique to each picture is printed on an index print in association with each of the small sized pictures as described above with reference to FIG. 4.

Processes after produced the index print are almost the same as those described in the abovementioned first print embodiment. When a user (27) has the cellular phone 30 read access information on the index print and recognizes the access information, and (28) accesses pictures and additional information by using the obtained access information, the service server 10 sends the pictures and additional information and the like corresponding to the access information to the cellular phone 30. (30) The period for storing the picture and additional information can be extended by paying an additional charge (storage charge). A user can also apply for Owner Picture Management Service that allows pictures to be managed for each owner of pictures. (31) In Owner Picture Management Service, the service server 10 manages pictures for each owner by using an owner ID and a password. (32) A user can also access the picture and additional information from the PC 40.

When a user delivers copies of an index print having access information printed thereon to other users, each of the users selects one or more desired pictures from pictures on the index print and has each one's cellular phone 30 read in the access information so as to view the pictures corresponding to the read access information on the screen of the cellular phone 30 or to get additional information added to the pictures. For example, a user can enjoy true-to-life representation on cellular phone 30 when the user sees at the pictures taken by another user on the screen of the cellular phone 30 and hears a voice message spoken by the object of the picture or the user who took the picture output from the cellular phone 30. A user may also easily select one or more desired pictures on the index print, looking forward to find the additional information on the pictures. If a user views a picture that selected on the index print on cellular phone 30 and likes it, the user may set the picture as a wallpaper, as desired.

When a user orders for an index print, the user may also specify whether or not the index print includes access information.

In ordering for an index print, a user may specify whether the user is authorized to write the access information to be printed on the index print (authorized to register additional information and the like) or the user is only authorized to read the access information (authorized to play a picture and additional information).

If an owner of pictures keeps an index print with access information that the owner is authorized to write and has the owner's cellular phone 30 read the access information, a registration screen is sent from the service server 10 and displayed on the cellular phone 30 and the owner can add or update additional information. The owner may deliver copies of an index print having access information printed thereon, to which other users are only authorized to add additional information, to other users in order to collect additional information.

When a user orders for an index print, the user may also select whether or not access information is to be printed thereon.

Access information can be printed on not only on an index print but also on a “photograph print,” the standard type of a print that includes only one picture.

Access information is not limited to be printed near a picture in the form of a two-dimensional barcode and it can be invisibly embedded in a picture. In such a case, the access information is preferably printed in the center of a picture.

Access information may be written on an IC tag formed on a sheet of paper. If eight pictures are to be printed on a sheet of paper in the form of an index print, a sheet of paper with IC tags formed in the center of places for eight pictures is used. The printing device 20 is provided with a writing device for a user to write access information on an IC tag. IC tags with appropriate communication range should be selected so that adjacent IC tags are not interfered with each other.

The present invention is not limited to the examples shown in the drawings or described above and any aspects can be implemented within a sprit of the present invention.

Although the printing device 20 is connected with the service server 10 over Internet 50 in FIG. 1, the printing device 20 and service server 10 can be integrated into one unit. Although the databases 13, 14, 15, and 16 are integrated with the communication part 11 and the controlling part 12 in the service server 10 in FIG. 2 for convenience of the description, the databases 13, 14, 15, and 16 can be connected with the communication part 11 and the controlling part 12 over a network. A user terminal is not limited to the cellular phone 30 or the PC 40 and can be PDA (Personal Digital Assistants).

Access information is not limited to be recorded on an index print by being printed as a two-dimensional barcode or by being written on an IC tag. Access information is not limited to be obtained from an index print by being read as a two-dimensional barcode by a camera or by being read an IC tag. Access information can be printed on an index print in the form of numbers, for example.

Additional information is not limited to the abovementioned sound information, text information, background music, and location information, and can be another type of picture information added to a picture. For example, as a picture printed on an index print is a still picture, a user has more fun if moving picture can be accessed by using access information.

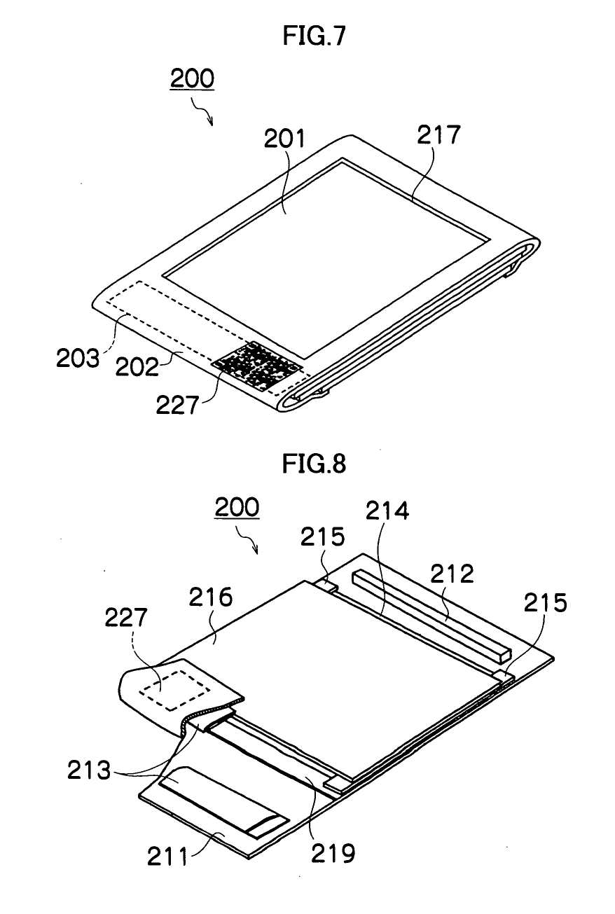

FIG. 7 is a perspective view of the exterior of a side displaying a picture on an instant film of an embodiment according to the present invention.

In FIG. 7, an instant film 200 is composed mainly of a print section 201 where a picture is printed and a frame section 202 surrounding the print section 201. A two-dimensional barcode 227 (encoded access information) is recorded on the frame section 202 to be used by a user terminal such as a cellular phone to obtain digital contents from a predetermined server over a network.

FIG. 8 is a perspective view of a reverse side of the instant film 200. The inside structure is shown with both tips unfolded and a part of one tip cut in.

In FIG. 8, a developer pod 213 is a bag containing developing solution. The developer pod 213 is glued to an end of a mask sheet 211 to be folded back. Although the developer pod 213 is cut in FIG. 8, the developer pod 213 is actually continuous. A trap material 212 is for receiving the remainder of developing solution. The trap material 212 is glued to the other end of the developer pod 213 on a folded part of the mask sheet 211. A photosensitive sheet 214 is glued to the mask sheet 211. An under sheet 219 defines the developer pod 213 so that developing solution from the developer pod 213 can fill the space between the photosensitive sheet 214 and a cover sheet 216. A spacer 215 keeps a certain distance between the photosensitive sheet 214 and the cover sheet 216 so that developing solution fills there evenly.

When the photosensitive sheet 214 is exposed through the cover sheet 216, the instant film 200 is sent under the roller of the instant camera (or a portable printer) from the side of the developer pod 213 and the developer pod 213 is torn open. Then, developing solution fills the space between the photosensitive sheet 214 and the cover sheet 216. When the developing solution fills the space, a latent image of the photosensitive sheet 214 is formed on the side displaying a picture on the photosensitive sheet 214 and a positive picture appears on the print section 201 shown in FIG. 7. The trap material 212 receives the remainder of developing solution.

The correlation between the print section 201 and the frame section 202 shown in FIG. 7 and components shown in FIG. 8 is like this: the print section 201 shown in FIG. 7 corresponds to a part of the photosensitive sheet 214 shown in FIG. 8 on a side displaying a picture that is defined by a screen opening 217. Frame section 202 shown in FIG. 7 corresponds to a part of a frame near the screen opening 217 over the photosensitive sheet 214 that is over where a picture appears on the mask sheet 211 shown in FIG. 8 near the screen opening picture 217.

The inside structure of the instant film 200 shown in FIG. 8 is just an example, and the present invention is not limited to this example. For example, the developer pod 213 and the trap material 212 may not glued to the mask sheet 211 and can be incorporated with the mask sheet 211 as one unit.

The two-dimensional barcode 227 shown in FIG. 7 is recorded on the frame section 202 at the side provided with the developer pod 213 in the place just over the developer pod 213 to keep its part big enough for containing the information to be encoded, while keeping the whole size of the instant film 200. When the two-dimensional barcode 227 does not need the size as big as the width of the developer pod 213, the two-dimensional barcode 227 may be recorded at the side provided with the trap material 212 to prevent the developing solution from changing the appearance. The two-dimensional barcode 213 can be recorded in the place neither over the developer pod 213 nor over the trap material 212.

Although only one two-dimensional barcode 227 is recorded in FIG. 7, more two-dimensional barcodes with different information can be recorded.

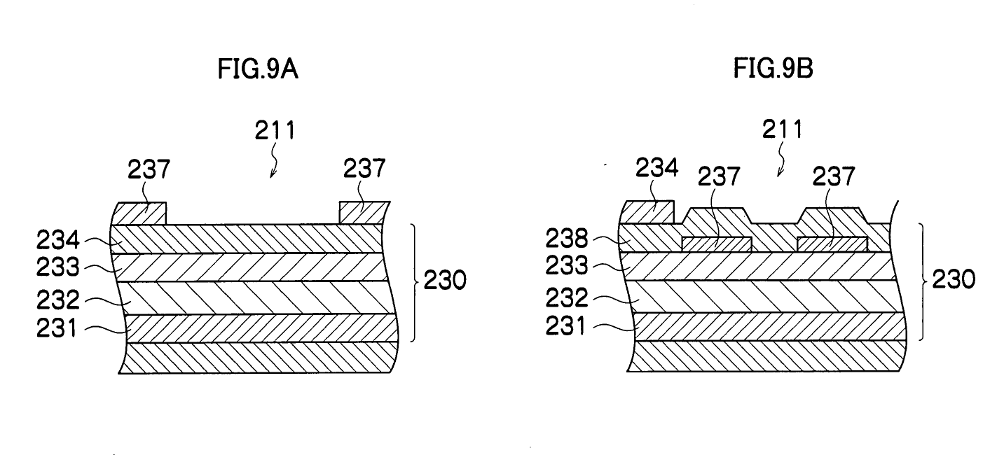

Aspects of recording two-dimensional barcode 227 on the frame 202 include two aspects: An aspect to record two-dimensional barcode 227 by a step of printing white section on the mask sheet 211 included in the frame section 202 and a following step of printing the two-dimensional barcode 227 over there; and an aspect to record the two-dimensional barcode 227 on the frame section 202 when the instant film 200 completes. An example of the former aspect will be described with reference to FIGS. 9A and 9B.

In an example shown in FIG. 9A, a first color layer 231, a second color layer 232, a third color layer 233, and a fourth color layer 234 forming a surface 230 of the mask sheet 211 are prepared by repeatedly coating white color over there and a barcode recording layer 237 recording a two-dimensional barcode is made over the fourth color layer 234.

In an example shown in FIG. 9B, the first color layer 231, the second color layer 232, and the third color layer 233 are prepared by repeatedly coating white color there and the barcode recording layer 237 recording a two-dimensional barcode is made over the third color layer 233, then an achromatic colored barcode protection layer 238 for protecting the two-dimensional barcode and the fourth color layer 234 is made over the barcode recording layer 237.

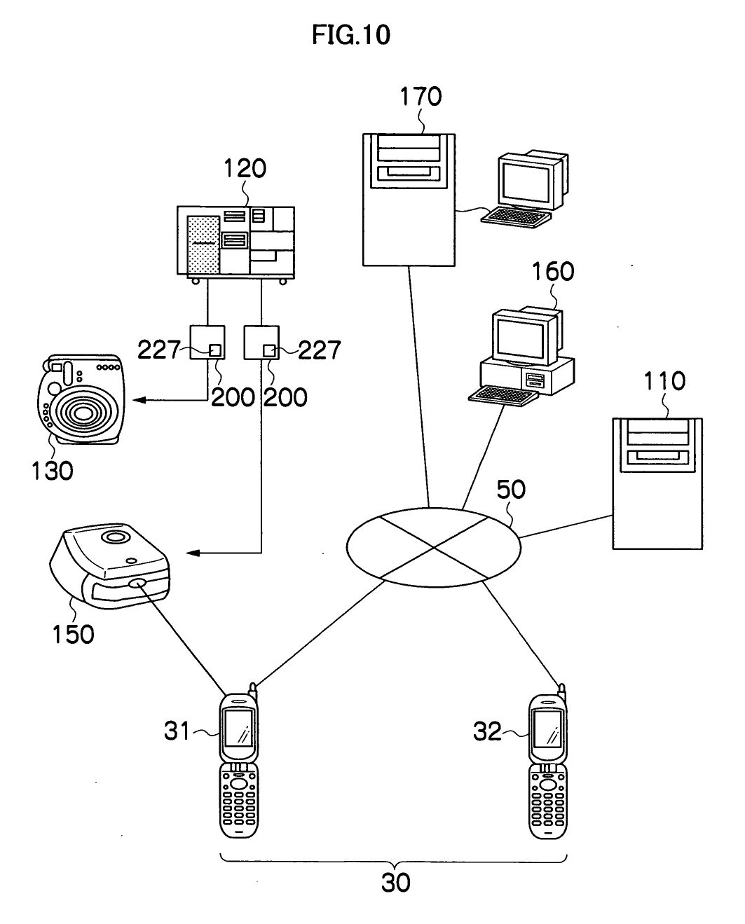

FIG. 10 is a view of whole configuration illustrating an outline of a server system including a service server of a second embodiment according to the present invention.

In FIG. 10, a service system is composed mainly of a service server 110, an instant film producing device 120, an instant camera 130, a camera cellular phone 30 (hereinafter called “cellular phone”), a portable printer 150, an information registration terminal 160, a management device 170, and an Internet 50.

The instant film producing device 120 produces the instant film 200 recording the two-dimensional barcode 227 (encoded accessing information) on its frame section.

The instant camera 130 prints a taken picture of a user on a print section of the instant film 200 after taking picture of the object.

The cellular phone 30 (31, 32) is provided with a camera that can take a picture of an object (not shown). The camera is also used for inputting two-dimensional barcode 227 (encoded access information) such as QR code (Registered Trademark). The cellular phone 30 decodes the two-dimensional barcode 227 indicating access information input by a camera and accesses the service server 110 over the Internet 50. The cellular phone 30 is actually connected to the Internet 50 via a base station (not shown) for wirelessly communicating with the cellular phone 30. Two cellular phones 31 and 32 are shown in FIG. 10, numerous cellular phones are actually connected to the Internet 50.

For simplicity of description, it is assumed that the cellular phone 31 is used for taking a picture of an object or inputting digital contents (hereinafter simply called “contents”) and the cellular phone 32 is used for outputting “contents.” This is considered as such just for simplicity of description and the cellular phone 31 can input and output contents.

The portable printer 150 performs short-range wireless communication through infrared rays with the cellular phone 31 that took a picture of an object, receiving a user's picture from the cellular phone 31, and printing the received picture on a print section of the instant film 200.

The information registration terminal 160 is a personal computer or the like and used for registering contents to be delivered to the cellular phone 32.

Contents includes sound information, moving picture information, still picture information, text information, vector graphics animation information, and a multimedia file containing the combination thereof.

The service server 110 communicates with the cellular phone 30, the information registration terminal 160, and the management device 170 over the Internet 50 for performing various services.

Aspects of printing a user's picture on the instant film 200 include two aspects in the example shown in FIG. 10: First aspect is that a picture of an object is taken by the instant camera 130 and the obtained user's picture is immediately printed on the instant film 200 in the instant camera 130; and second aspect is that a picture of an object is taken by the cellular phone 31, the obtained user's picture is transferred from the cellular phone 31 to the portable printer 150, and the picture is printed on the instant film 200 in the cellular printer 150.

Aspects of delivering contents to the cellular phone 32 by using access information recorded on the instant film 200 include two aspects in the example shown in FIG. 10: First aspect is that contents uploaded from the cellular phone 31 to the service server 110 over the Internet 50 is downloaded to the cellular phone 32 over the Internet 50; and second aspect is that contents uploaded from the information registration terminal 160 to the service server 110 over the Internet 50 is downloaded to the cellular phone 32, which requested the contents to be delivered.

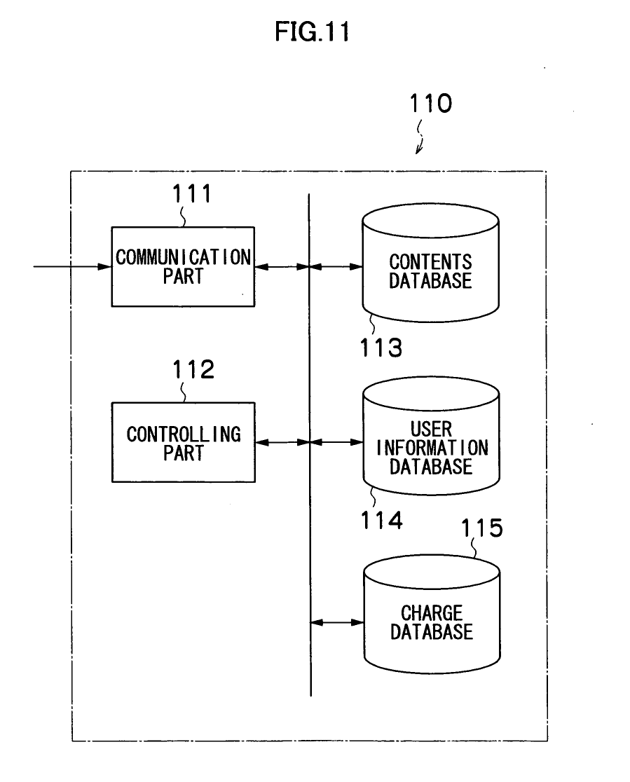

FIG. 11 is a block diagram illustrating a specific example of inside structure of the service server 110. In FIG. 11, the service server 110 is composed mainly of a communication part 111 for communicating with the cellular phone 30, the information registration terminal 160, and the management device 170 over the Internet 50, a controlling part 112 including CPU (Central Processing Unit), a contents database 113 for storing and managing contents, a user information database 114 for managing information on a user, and a charge information database 115 for managing information on a charge to a user. Each of databases 113 and 115 does not need to be in a housing of the service server 110 and can be placed distant from the service server 110 and connected to the service server 110 over the Internet 50 shown in FIG. 10, for example.

The communication part 111 receives contents from the information registration terminal 160 or the cellular phone 30. The communication part 111 is accessed from the cellular phone 30 and delivers contents to the accessing cellular phone 30. An instruction for setting access authorization information for access information is input from the management device 170 to the communication part 111.

The communication part 111 can communicate with the cellular phone 30 according to HTTP (Hyper Transfer Protocol). The controlling part 112 generates screen information to be displayed on the screen of the cellular phone 30.

An aspect of delivering contents uploaded from the cellular phone 30 and an aspect of delivering contents uploaded from the information registration terminal 160 will be described below. The aspects are divided as such only for simplifying the description and an aspect of delivering multiple contents uploaded from both cellular phone 30 and the information registration terminal 160 is also possible.

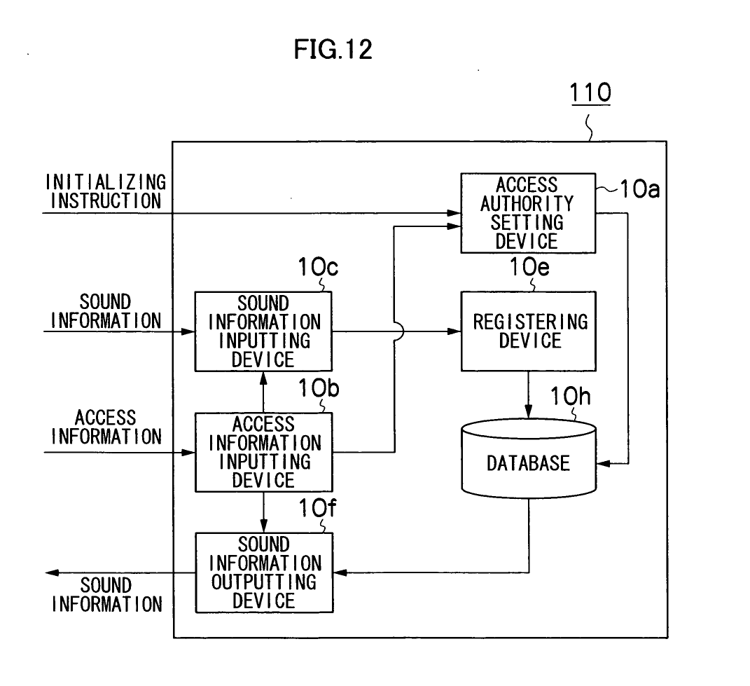

FIG. 12 is a block diagram illustrating a conceptual configuration of a service server 110 of the second embodiment. The service server 110 of the second embodiment provides a service (sound information collection service) to collect sound information input from a user's cellular phone 30 for each piece of access information.

In FIG. 12, the service server 110 is composed mainly of an access authority setting device 10a, an access information inputting device 10b, a sound information inputting device 10c, a registering device 10e, a sound information outputting device 10f, and a database 10h.

The access authority information device 10a sets access authority from the cellular phone 30 for each piece of access information for multiple instant films 200 manufactured and appearing on the market. When access information unique to each instant film is recorded, access authority is set for each instant film. When access information unique to each package including a predetermined number (e.g., ten) of instant films is recorded, access authority is set for each package.

For access authority, any of “permitted to input”, “permitted to output”, and “access protected” is set. Access authority is initialized on the basis of an initializing instruction input from the management device 170. For example, access authority is initialized for all types of instant film 200 manufactured and appearing on the market. Access authority is updated on the basis of accessing state from the cellular phone 30. Access authority is updated when sound information is input form the cellular phone 30 and access authority is updated to access protected when a group of pieces of sound information is recorded on (output to) a removable recording medium such as CD (Compact Disk) or after a predetermined days and hours.

The access information inputting device 10b inputs access information from the cellular phone 30 over the Internet 50 when the cellular phone 30 recognizes the access information on the instant film 200.

The sound information inputting device 10c inputs sound information from the cellular phone 30 that sent access information over the Internet 50 when the access information is input to the access information inputting device 10b and requirement for inputting sound information is made.

The registration device 10e registers sound information input from the cellular phone 30 that sent the access information with later described database 10h in association with each piece of access information.

The sound information outputting device 10f outputs a group of pieces of sound information stored in the database 10h in association with access information when the access information is input to the access information inputting device 10b and requirement for outputting the sound information is made. Aspects of outputting sound information include: First aspect of outputting a group of piece of sound information to cellular phone 30 that sent access information over the Internet 50; and second aspect of recording (outputting) sound information on (to) a removable recording medium such as CD (Compact Disk).

The correlation between components of the service server 110 in conceptual configuration shown in FIG. 12 and components of the service server 110 in specific example shown in FIG. 11 will be simply shown as below: The access authority setting device 10a and the registration device 10e are mainly included in the controlling part 112; and the access information inputting device 10b, the sound information inputting device 10c, and the sound information outputting device 10f are mainly included in the communication part 111 and the controlling part 112.

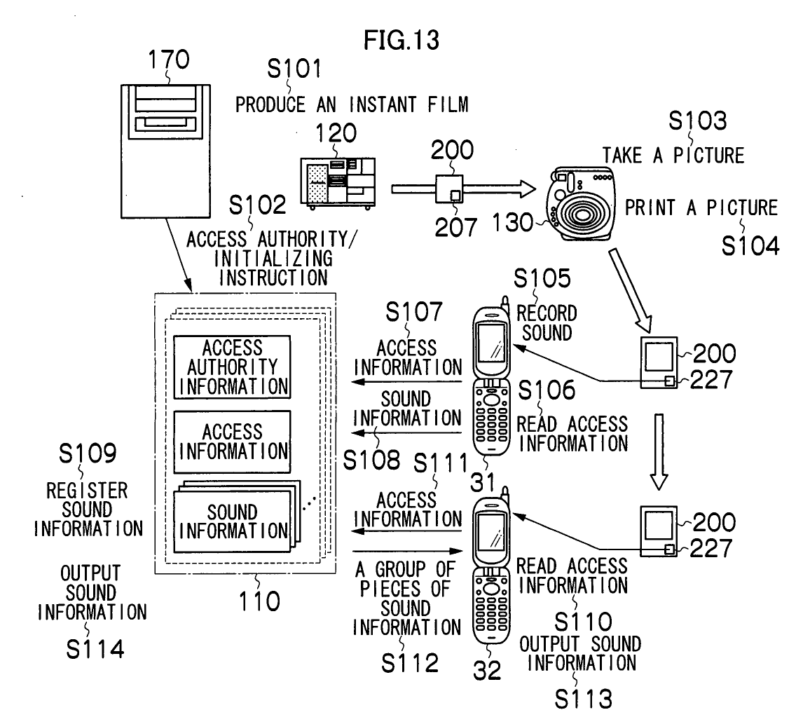

A flow of a specific service (sound information collecting service) in the second embodiment will be described with reference to FIG. 13.

In FIG. 13, instant film producing device 120 produces the instant film 200 recording access information (S101). Now, the instant film 200 is considered to record access information unique to each film.

The produced instant film 200 is put on general market with a predetermined number (e.g., ten) in a package. The management device 170 manages the range of access information for the instant film 200 appearing on the market. An instruction to initialize access authority to “permission to input” is input from the management device 170 to the service server 110 (S102).

A user purchased the instant film 200 sets a package of the instant films 200 in the instant camera 130 and manipulates the instant camera 130 to take a picture of an object. Then, the instant camera 130 takes a picture of the object (S103) and the picture is immediately printed on a print section of the instant film 200 (S104).

Although the instant camera 130 takes a picture of an object and prints the picture in the example of FIG. 13, the present invention is not limited to this example, and the cellular phone 31 can take a picture of an object and transfer the taken picture to the portable printer 150 shown in FIG. 10 by means of short-range wireless communication through infrared rays, then have the portable printer 150 print the picture on the instant film 200.

The user takes the instant film 200 (also referred as “photograph print”) printed with the picture and records sound information by the cellular phone 31 (S105). Then the user sets the cellular phone 31 to access information reading mode and have the cellular phone 31 read two-dimensional barcode 227 on the photograph print (encoded access information) (S106). The two-dimensional barcode 227 is decoded at the cellular phone 31 and the decoded access information is sent from the cellular phone 31 to the service server 110 (S107).

The service server 110 receives the access information from the cellular phone 31, determines whether the received access information is authorized access information or not. If the received access information is authorized, the service server 110 continues to receive sound information from the cellular phone 31 (S108). Whether or not the access information is authorized can be determined by determining whether the access information is associated with an instant film produced by the instant film producing device 120 or not, or whether access authority is set to “permission to input” for the access information or not, for example. Then the received sound information and access information are registered with the database 10h in association with each other (S109).

Sound information is permitted to be input from the cellular phone 31 just for once or to be input for multiple times until input from the cellular phone 31 finishes. When sound information is permitted to be input for multiple times, sound is permitted to be input until access authority is updated to permission to output. In this case, permission to input sound is not limited to a user and any number of users may input sound from the users' cellular phone 31. The database 10h stores a group of pieces of sound information for each piece of access information. Access authority for access information associated with sound information that has already input is set to “permission to output.”

A user receives the delivered photograph print (an instant film 200 printed with a picture) after sound information is input, sets the user's cellular phone 32 to access information reading mode, and have the cellular phone 32 read two-dimensional barcode 227 (encoded access information) on the photograph print 200 (S110). The two-dimensional barcode 227 is decoded at cellular phone 32 and the decoded access information is sent from the cellular phone 32 to the service server 110 (S111).

The service server 110 receives access information from the cellular phone 32, determines whether the received access information is authorized access information or not. If the received access information is authorized, the service server 110 sends a group of pieces of sound information associated with the access information stored in database 10h to the cellular phone 32 that sent the access information over the Internet 50 (S112). Whether or not the access information is authorized can be determined by determining whether the access information is associated with an instant film produced by the instant film producing device 120 or not, or whether access authority is set to “permission to output” for the access information or not, for example.

A group of pieces of sound information sent to the cellular phone 32 that sent access information is played at the cellular phone 32 (S113).

A group of pieces of sound information stored in the database 10h can be written on a removable recording media such as CD (Compact Disk) (S114). For example, access information is directly input to the service server 110 from manipulation panel (not shown), which is directly or indirectly connected with the service server 110, a group of pieces of sound information is searched from the database 10h for each piece of access information, and the group of pieces of sound information is recorded on CD by using CD-R (CD Recordable) (not shown), which is directly or indirectly connected with the service server 110.

For example, a user takes pictures of newly-weds or people attending a wedding reception with the instant camera 130, in which the user has set the instant film 200 with the two-dimensional barcode 227 (encoded access information). A person attending the reception records a message to congratulate the couple from the person's cellular phones 31, have their cellular phones 31 recognize the two-dimensional barcode 227 on the instant film 200 with recorded pictures (photograph print), and input their message to congratulate the couple to the service server 10. If multiple people input their messages individually, the messages are stored in the database 10h for each piece of access information, i.e., for each photograph print. For example, various messages to congratulate the couple like “Best wishes! from X”, “Thank you very much for your invitation today. from Y”, “I wish you joy! from Z” are stored in database 10h in association with pictures. A person may drop a line in the margin of a frame section on the instant film 200 (e.g., “from your friends”).

When all messages to congratulate the couple have recorded, a group of messages are written in CD as sound information. In addition to the sound information, the photograph print with a handwritten message is written with a scanner and the picture obtained by the scanner can be recorded.

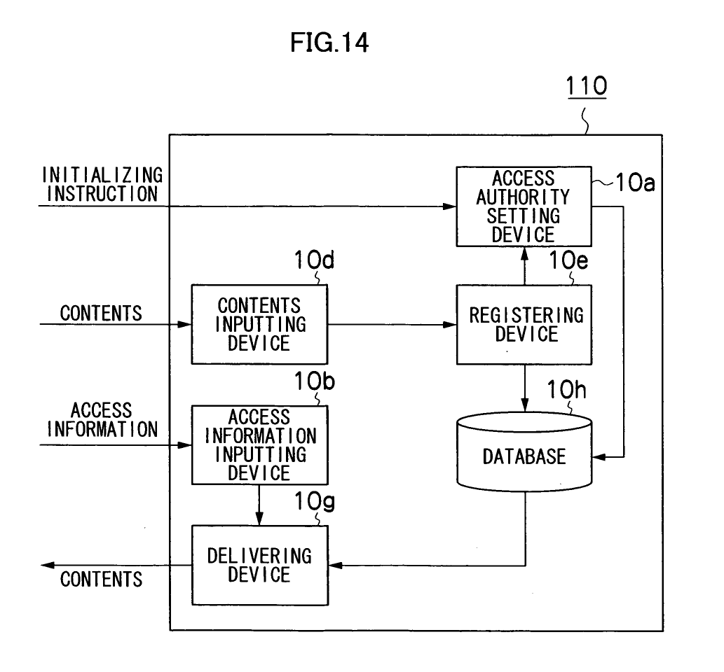

FIG. 14 is a block diagram illustrating a conceptual configuration of a service server 110 of the third embodiment. The service server 110 of the third embodiment provides a service (contents delivering service) for delivering contents for each piece of access information input from the information registration terminal 160.

In FIG. 14, the service server 110 is composed mainly of an access authority setting device 10a, an access information inputting device 10b, a contents inputting device 10d, a registration device 10e, a delivering device 10g, and a database 10h.

The access authority setting device 10a sets access authority from the cellular phone 30 for each piece of access information for multiple instant films 200 manufactured and appearing on the market. When an image of a character is printed on a frame section of the instant film 200 and access information unique to each type of images is recorded, access authority is set for each type of images.

For access authority, any of “unregistered”, “permitted to be output”, and “access protected” is set. For access information, for which content has been registered with the database 10h by the registration device 10e, “permitted to be output” is set. For access information that is over a predetermined days and hours (for example, the last day of a specific year), “access protected” is set.

The contents inputting device 10d is for inputting contents from the information registration terminal 160 over the Internet 50.

When access information is assigned to each type of character images, contents such as sound information or moving picture information corresponding to the image is input for each type of the images, i.e., for each piece of access information. If the frame section has a cat character printed on it, sound information or moving picture information associated with the cat character is input.

The registration device 10e registers contents input to the contents inputting device 10d with the later described database 10h in association with each piece of access information.

The access information inputting device 10b is for inputting access information from the cellular phone 30 over the Internet 50 when the cellular phone 30 recognizes the access information on the instant film 200.

The delivering device 10g delivers contents managed in the database 10h in association with access information to the cellular phone 30 over the Internet 50 when the access information is input to the access information inputting device 10b and requirement for delivering the contents is made.

The correlation between components of the service server 110 in conceptual configuration shown in FIG. 14 and components of the service server 110 in specific example shown in FIG. 11 will be simply shown as below: the access information inputting device 10b, the contents inputting device 10d, and the delivering device 10g are mainly included in the communication part 111 and the controlling part 112; and the access authority setting device 10a and the registration device 10e are mainly included in the controlling part 112.

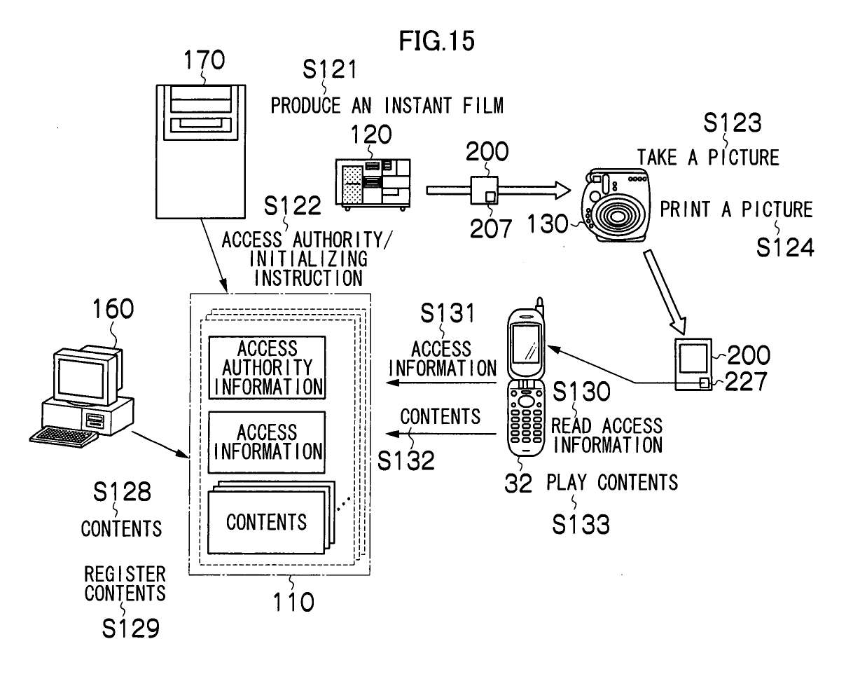

A flow of a specific service in the third embodiment (contents delivering service) will be described with reference to FIG. 15.

In FIG. 15, the instant film producing device 120 produces the instant films 200 with recorded access information (S121). Here, it is assumed that an image representing a character such as a cat is printed on a frame section with access information. In the description below, access information unique to each type of the images is assumed to be recorded on the instant film 200.

The produced instant films 200 are put on general market with a predetermined number (e.g., ten) in a package. The management device 170 manages the range of access information for the instant film 200 appearing on the market. An instruction to initialize access authority to “unregistered” is input from the management device 170 to the service server 110 (S122).

A user purchased the instant film 200 sets a package of instant films 200 in the instant camera 130 and manipulates the instant camera 130 to take a picture of an object. Then, the instant camera 130 takes a picture of the object (S123) and the picture is immediately printed on a print section of the instant film 200 (S124).

Although the instant camera 130 takes a picture of an object and prints the picture in the example of FIG. 15, the present invention is not limited to this example, and the cellular phone 31 can take a picture of an object and transfer the taken picture to the portable printer 150 shown in FIG. 10 by means of short-range wireless communication through infrared rays, then have portable printer 150 print the picture on the instant film 200.

On the other hand, contents are input from the information registration terminal 160 to the service server 110 (S128). The input contents are registered with the database 10h in association with access information to be recorded in the instant film 200 (S129). Access authority for access information associated with registered contents is set “permitted to output.”

The user takes the instant film 200 (photograph print) with a picture printed on it has the cellular phone 32 read tow-dimensional barcode 227 (encoded access information) on the instant film 200 (S130). Then, the tow-dimensional barcode 227 is decoded at the cellular phone 32 and access information decoded from the barcode is sent from the cellular phone 32 to the service server 110 (S131).

The service server 110 receives the access information from the cellular phone 32, determines whether the received access information is authorized access information or not. If the received access information is authorized, the service server 110 sends contents associated with the access information stored in the database 10h to the cellular phone 32 that sent the access information over the Internet 50 (S132). Whether or not the access information is authorized can be determined by determining whether the access information is associated with an instant film produced by the instant film producing device 120 or not, or whether access authority is set to “permitted to output” for the access information or not, for example. If access authority is “unregistered,” i.e., contents corresponding to the access information is “unregistered,” the common contents can be delivered to the cellular phone 32 so that a user who pays a charge will get something.

The contents sent to the cellular phone 32 that sent the access information is played on the cellular phone 32 (S133).

If the instant film 200 has an image of a cat character on it, a voice message with a recorded well-known voice as the cat character's voice or vector graphics animation information representing actions of the character are delivered to cellular phone 32. If the instant film 200 has an image of a mouse character on it, a voice message with a recorded well-known voice as the mouse character's voice or vector graphics animation information representing actions of the character are delivered to the cellular phone 32. Different contents can be delivered to according to accessing date and time, accessing location, or accessing times. Contents delivered to the cellular phone 32 may be advertisement information.

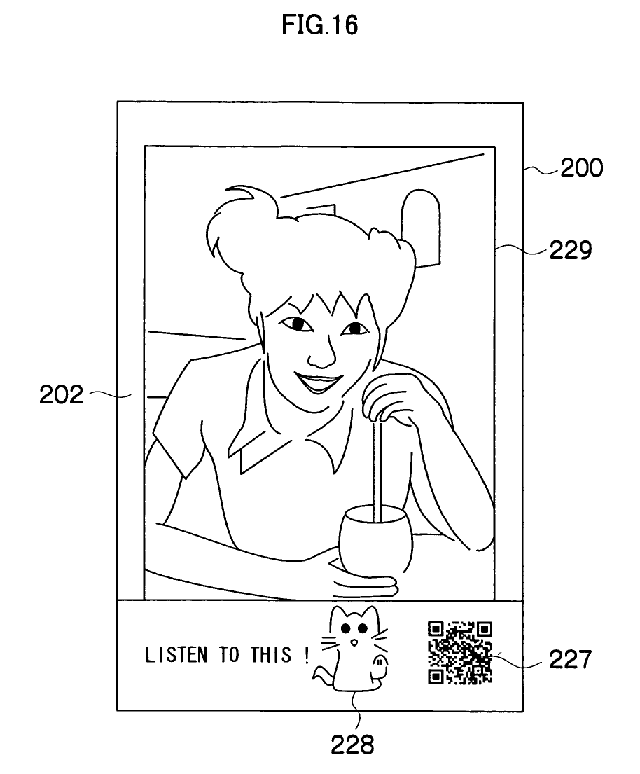

FIG. 16 shows an example of the instant film 200 with a picture 229 printed on it (photograph print). Two-dimensional barcode 227, i.e., encoded access information is recorded on a frame section 202 surrounding the picture 229. A picture of character 228 is printed on the frame section 202 with two-dimensional barcode 227. The picture of character 228 is previously printed with two-dimensional barcode 227 by the instant film producing device 120.

The instant film 200 may be sold with a margin in the frame section 202 so that a user can write a message on the sheet after the picture 229 has been printed.

Although only one two-dimensional barcode 227 is recorded in FIG. 16, multiple two-dimensional barcodes 227 may be recorded. When the cellular phone 30 recognizes a first two-dimensional barcode, the multimedia file associated with the cat character printed near the first two-dimensional barcode can be delivered and the multimedia representing actions of the cat character is played on the screen of the cellular phone 30. When the cellular phone 30 recognizes a second two-dimensional barcode, the multimedia file associated with the mouse character printed near the second two-dimensional barcode is delivered and the multimedia representing actions of the mouse character is played on the screen of the cellular phone 30.

Although not limited to the examples, the present invention has been described for the case that access information is recorded in the frame section 202 on the instant film 200 as two-dimensional barcode. An IC (Integrated Circuit) tag may be formed on the frame section 202 on the instant film 200 and access information may be printed in the form of digital data on the IC tag on the frame section 202. In such a case, the instant film producing device 120 is provided with writing device for writing access information on an IC tag. The cellular phone 30 is provided with reading device for reading access information from an IC tag.

A user terminal is not limited to a cellular phone and may be PDA (Personal Digital Assistant), for example.

The present invention is not limited to the examples shown in the drawings and the embodiments described and can be updated or improved in design if needed without departing from the spirit of the present invention.

1. An index printing device comprising:
a picture obtaining device for obtaining at least one picture of a user whose order for printing is received;
an access information obtaining device for obtaining access information unique to each picture; and
a printing device for printing the at least one picture of the user on a sheet of print medium for index print and recording the access information unique to each picture in association with each picture.

2. The index printing device according to claim 1, wherein the print medium is an adhesive sheet, which allows a section having the access information printed thereon to be peeled off and applied to another medium.

3. The index printing device according to claim 1, wherein the access information is information for accessing each picture of the user or additional information associated with each picture of the user registered with a predetermined database over a network.

4. The index printing device according to claim 2, wherein the access information is information for accessing each picture of the user or additional information associated with each picture of the user registered with a predetermined database over a network.

5. The index printing device according to claim 3, wherein the printing device prints the access information on a print medium in the form of a two-dimensional barcode.

6. The index printing device according to claim 4, wherein the printing device prints the access information on a print medium in the form of a two-dimensional barcode.

7. The index printing device according to claim 3, wherein the access information is printed on a print medium in the form of text.

8. The index printing device according to claim 4, wherein the access information is printed on a print medium in the form of text.

9. The index printing device according to claim 3, wherein the printing device includes writing device for writing the access information on an IC (Integrated Circuit) tag formed on the print medium.

10. The index printing device according to claim 4, wherein the printing device includes writing device for writing the access information on an IC (Integrated Circuit) tag formed on the print medium.

11. A service server for communicating over a network with a user terminal that uses access information on an index print produced by an index printing device of claim 1, comprising:
a database for managing each picture of a user whose order for printing is received; and
a sending device for reading out a picture corresponding to the access information from the database and sending the picture to the accessing user terminal in response to an access using the access information on the index print from the user terminal.

12. A service server for communicating over a network with a user terminal that uses access information on an index print produced by an index printing device of claim 1, comprising:
a database for managing additional information associated with each picture of a user whose order for printing is received in association with each picture; and
a sending device for reading out additional information on a picture corresponding to the access information from the database and sending the additional information to the accessing user terminal in response to an access using the access information on an index print from the user terminal.

13. A service server for communicating over a network with a user terminal that uses access information on an index print produced by an index printing device of claim 1, comprising:
a receiving device accessed from the user terminal that uses access information on an index print, the receiving device for receiving additional information on a picture corresponding to the access information;
a database for managing the received additional information in association with each picture; and
a sending device for reading out additional information on a picture corresponding to the access information from the database and sending the additional information to the accessing user terminal in response to an access using the access information on an index print from the user terminal.

14. The service server according to claim 12, wherein the additional information includes at least one of sound information, text information, background music, location information indicating where the picture was taken, and picture information.

15. The service server according to claim 13, wherein the additional information includes at least one of sound information, text information, background music, location information indicating where the picture was taken, and picture information.

16. A servicing method comprising the steps of:
receiving an order for printing at least one picture of a user;
registering each of the pictures of a user whose order for printing is received with a predetermined database;
issuing access information unique to each picture for accessing each picture registered with the database over a network;
printing at least one picture of the user on a sheet of print medium for index print, while recording access information unique to each of the pictures on the print medium in association with each picture; and
reading out a picture corresponding to the access information from the database and sending the picture to the accessing user terminal in response to an access from a user terminal that uses the access information on the print medium.

17. A servicing method comprising the steps of:
receiving an order for printing at least one picture of a user;
registering additional information associated with each of the pictures of a user whose order for printing is received with a predetermined database in association with each picture;
issuing access information unique to each picture for accessing additional information on each picture registered with the database over a network;
printing at least one picture of the user on a sheet of print medium for index print, while recording access information unique to each of the pictures on the print medium in association with each picture; and
reading out additional information on a picture corresponding to the access information from the database and sending the additional information on the accessing user terminal in response to an access from a user terminal that uses the access information.

18. A servicing method comprising the steps of:
receiving an order for printing at least one picture of a user;
issuing access information unique to each of the pictures;
printing at least one picture of the user on a sheet of print medium for index print, while recording access information unique to each of the pictures on the print medium in association with each picture;
being accessed from a first user terminal by using the access information and receiving additional information on a picture corresponding to the access information;
registering the received additional information with a predetermine database in association with each picture; and
reading out additional information on a picture corresponding to the access information from the database and sending the additional information to an accessing second user terminal in response to an access from a second user terminal that uses the access information on the print medium.

19. An instant film including:
a print section in which a taken picture of an object is to be printed; and
a frame section surrounding the print section,
wherein an access information for a user terminal to obtain digital contents that can be played by the user terminal over a network from a predetermined server is recorded in the frame section.

20. The instant film according to claim 19, wherein the access information is recorded on the frame section in the form of two-dimensional barcode.

21. A service server for communicating with a user terminal over a network and collecting sound information from the user terminal, comprising:
a database for storing sound information in association with access information recorded on the instant film of claim 19;
an access information inputting device to which access information on an instant film with a picture printed thereon is input from a user terminal over a network;
a sound information inputting device to which sound information is input from a user terminal, which sent the access information, over a network;
a registering device for registering sound information input from the user terminal, which sent the access information, with the database in association with the access information; and
a sound information outputting device for outputting a group of pieces of sound information for each piece of access information stored in the database.

22. A service server for communicating with a user terminal over a network and collecting sound information from the user terminal, comprising:
a database for storing sound information in association with access information recorded on the instant film of claim 20;
an access information inputting device to which access information on an instant film with a picture printed thereon is input from a user terminal over a network;
a sound information inputting device to which sound information is input from a user terminal, which sent the access information, over a network;
a registering device for registering sound information input from the user terminal, which sent the access information, with the database in association with the access information; and
a sound information outputting device for outputting a group of pieces of sound information for each piece of access information stored in the database.

23. The service server according to claim 21, wherein the sound information outputting device retrieves a group of pieces of sound information for each piece of access information stored in the database from the database and records the group of pieces of sound information on a removable recording medium.

24. A service server for communicating with a user terminal over a network and delivering digital contents that can be played on the user terminal to the user terminal, comprising:
a database for managing digital contents to be delivered to a user terminal in association with access information recorded on the instant film of claim 19;
an access information inputting device to which access information on an instant film with a picture printed thereon is input from a user terminal over a network; and
a delivering device for delivering digital contents managed in the database in association with the received access information to the user terminal.

25. A service server for communicating with a user terminal over a network and delivering digital contents that can be played on the user terminal to the user terminal, comprising:
a database for managing digital contents to be delivered to a user terminal in association with access information recorded on the instant film of claim 20;
an access information inputting device to which access information on an instant film with a picture printed thereon is input from a user terminal over a network; and
a delivering device for delivering digital contents managed in the database in association with the received access information to the user terminal.

26. The service server according to claim 24, wherein the digital contents is sound information, moving picture information, still picture information, text information, animation information of vector graphics, or a multimedia file including the combination thereof.

27. A servicing method comprising the steps of:
receiving an input of access information recorded on the instant film of claim 19 from a user terminal over a network;
receiving an input of sound information from the user terminal that sent the access information over a network;
registering sound information input from the user terminal that sent the access information with a predetermined database in association with the access information; and
outputting a group of pieces of sound information for each piece of access information stored in the database.

28. A servicing method comprising the steps of:
receiving an input of access information recorded on the instant film of claim 20 from a user terminal over a network;
receiving an input of sound information from the user terminal that sent the access information over a network;
registering sound information input from the user terminal that sent the access information with a predetermined database in association with the access information; and
outputting a group of pieces of sound information for each piece of access information stored in the database.

29. A servicing method comprising the steps of:
registering digital contents to be delivered to a user terminal with a predetermined database in association with access information recorded on the instant film of claim 19;
receiving an input of access information on an instant film with a picture printed thereon from a user terminal over a network; and
delivering digital contents managed in the database in association with the received access information to the user terminal over a network.

30. A servicing method comprising the steps of:
registering digital contents to be delivered to a user terminal with a predetermined database in association with access information recorded on the instant film of claim 20;
receiving an input of access information on an instant film with a picture printed thereon from a user terminal over a network; and
delivering digital contents managed in the database in association with the received access information to the user terminal over a network.
